(19) United States
(12) Patent Application Publication
(10) Pub. No.: US 2023/0234877 A1
(43) Pub. Date: Jul. 27, 2023

(54) BENDABLE GLASS AND SUBSTRATE ASSEMBLY AND ASSEMBLY METHODS

(71) Applicant: Polymer Process Development, LLC, Shelby Township, MI (US)

(72) Inventors: Daniel J. SMITH, Washington Twp., MI (US); Frank NOTHELLE, Imlay City, MI (US); Kenneth BORKOWSKI, Richmond, MI (US); Richard GIFFORD, Chesterfield, MI (US)

(21) Appl. No.: 17/582,700

(22) Filed: Jan. 24, 2022

(51) Int. Cl. C03B 23/023

(52) U.S. Cl. CPC C03B 23/023

(57) ABSTRACT

A bendable glass and substrate assembly including a glass panel that has a planar pre-installation geometry and first and second panel surfaces that are separated by a panel thickness and at least one substrate that is bonded to at least a portion of the first panel surface. Both the glass panel and the substrate are made of bendable materials and are adapted to take on at least one bent post-installation geometry that is different than the planar pre-installation geometry. The bendable materials of the glass panel and the substrate remain flexible and resilient even after the substrate is bonded to the glass panel and as a result the bendable glass and substrate assembly has a planar geometry before installation and is bent to a final non-planar shape or contour when the bendable glass and substrate assembly is mounted in a final installation.

### FIELD

The present disclosure generally relates to panel assemblies made of glass and a substrate using encapsulation and/or encapsulation assembly methods. More particularly, the present disclosure relates to glass and substrate assemblies that are bendable where the glass and substrate assemblies have a planar geometry before installation and are configured to be bent to a final non-planar shape or contour when they are mounted in a final installation.

### BACKGROUND

This section provides background information related to the present disclosure which is not necessarily prior art.

Glass and substrate assemblies are used in a wide variety of applications including, without limitation, consumer electronics, appliances, and in vehicles. For example, vehicles such as contemporary automobiles typically include glass panel assemblies as electronic display and/or touchscreen surfaces for dashboards, digital gauge clusters, infotainment systems, and digital switch gear. Opaque and/or textured glass panels can also be used in vehicle interiors as decorative trim pieces with or without integrated digital displays. These glass panel assemblies are typically rigid and have a static shape. For example, glass encapsulation molding is often used where rigid substrate materials are bonded to glass panels to form a perimeter frame of sorts along the edge of the glass panel. The use of large electric display screens and touchscreens has become prolific in many industries besides the automotive industry. As a result, there is increasing demand for new, unconventional solutions for an expanding number of glass panel applications.

### SUMMARY

This section provides a general summary of the disclosure, and is not a comprehensive disclosure of its full scope or all of its features.

In accordance with one aspect of the subject disclosure, a bendable glass and substrate assembly is provided. The bendable glass and substrate assembly includes a glass panel and at least one substrate that is bonded to at least a portion of the glass panel. The glass panel has a planar pre-installation geometry and first and second panel surfaces that are separated by a panel thickness. The substrate is bonded to at least a portion of the first panel surface. Both the glass panel and the substrate are made of bendable materials and are adapted to take on at least one bent post-installation geometry that is different than the planar pre-installation geometry. The bendable materials of the glass panel and the substrate remain flexible and resilient even after the substrate is bonded to the glass panel and as a result the bendable glass and substrate assembly has a planar geometry before installation and is bent to a final non-planar shape or contour when the bendable glass and substrate assembly is mounted in a final installation.

In accordance with another aspect of the present disclosure, a method for assembling the bendable glass and substrate assembly described above is provided. The method includes the steps of placing a flat pre-molded glass panel in a encapsulation mold, bonding a flexible resin substrate to at least a portion of the first panel surface by injecting the flexible resin substrate into the encapsulation mold to create a bendable glass and substrate assembly having a planar pre-installation geometry, and removing the bendable glass and substrate assembly from the encapsulation mold. The method continues with the step of installing the bendable glass and substrate assembly on a fixture. The step of installing the bendable glass and substrate assembly on the fixture includes bending the bendable glass and substrate assembly to a bent post-installation geometry that is different than the planar pre-installation geometry and fixably mounting the bendable glass and substrate assembly to the fixture to hold the bendable glass and substrate assembly in the bent post-installation geometry. Thus, the subject disclosure also provides for a method of installing the bendable glass and substrate assembly, which generally comprises the steps of positioning a bendable glass and substrate assembly over a fixture for installation, bending the bendable glass and substrate assembly to a bent post-installation geometry that is different than the planar pre-installation geometry of the glass panel and flexible substrate, and securing the bendable glass and substrate assembly to the fixture to hold the bendable glass and substrate assembly in the bent post-installation geometry.

Because both the glass panel and the flexible resin substrate are made of bendable materials, the bendable glass and substrate assembly returns to the planar pre-installation geometry after the substrate is bonded to the glass panel and the assembly is removed from the mold. This memory/resilience of the bendable glass and substrate assembly, which allows it to return to the planar pre-installation geometry, is advantageous. For example, there are shipping and handling benefits because the bendable glass and substrate assembly takes up less space (i.e., is flatter and more stackable) than permanently molded glass substrate assemblies and is also less prone to damage during shipping and handling. In addition, the same bendable glass and substrate assembly can be used across different fixture versions/configurations that have different bent post-installation geometries. Finally, the flexibility of the bendable glass and substrate assembly allows for dynamic trim components and electronics screens that can bend or change their curvature in response to mechanical movements of the fixtures to which they are mounted or in response to actuators, giving rise to new types of dynamic trim components and electronics screens that can change their shape as opposed to being rigid and static in shape.

### BRIEF DESCRIPTION OF DRAWINGS

The drawings described herein are for illustrative purposes only of selected embodiments and not all possible implementations, and are not intended to limit the scope of the subject disclosure.

FIG. 1 is a side cross-section view of an exemplary encapsulation molding machine that may be used for constructing the bendable glass and substrate assembly of the subject disclosure;

FIG. 2 is a top plan view of an exemplary vacuum block for the encapsulation molding machine illustrated in FIG. 1;

FIG. 3 is a front plan view of the exemplary vacuum block illustrated in FIG. 2;

FIG. 4 is a side plan view of the exemplary vacuum block illustrated in FIG. 2;

FIG. 5 is a top perspective view of the exemplary vacuum block illustrated in FIG. 2;

FIG. 6 is a top plan view of another exemplary encapsulation molding machine that may be used for constructing the bendable glass and substrate assembly of the subject disclosure;

FIG. 7 is a front plan view of the exemplary encapsulation molding machine illustrated in FIG. 6;

FIG. 8 is a side plan view of the exemplary encapsulation molding machine illustrated in FIG. 6;

FIG. 9 is a top plan view of an exemplary vacuum block for the encapsulation molding machine illustrated in FIGS. 6-8;

FIG. 10 is a front plan view of the exemplary vacuum block illustrated in FIG. 9;

FIG. 11 is a side plan view of the exemplary vacuum block illustrated in FIG. 9;

FIG. 12 is a top perspective view of the exemplary vacuum block illustrated in FIG. 9;

FIG. 13 is a front perspective view of an exemplary bendable glass and substrate assembly and an associated jig that have been constructed in accordance with the subject disclosure;

FIG. 14 is a top plan view of the exemplary bendable glass and substrate assembly illustrated in FIG. 13 where the glass panel and substrate are shown in a bent post-installation position;

FIG. 15 is a back plan view of the exemplary bendable glass and substrate assembly illustrated in FIG. 13 where the glass panel and substrate are shown in the bent post-installation position;

FIG. 16 is a side plan view of the exemplary bendable glass and substrate assembly illustrated in FIG. 13 where the glass panel and substrate are shown in the bent post-installation position;

FIG. 17 is a front perspective view of an exemplary bendable glass and substrate assembly and an associated installation fixture that have been constructed in accordance with the subject disclosure;

FIG. 18 is a top plan view of the exemplary bendable glass and substrate assembly illustrated in FIG. 17 where the glass panel and substrate are shown in a planar pre-installation position;

FIG. 19 is a back plan view of the exemplary bendable glass and substrate assembly illustrated in FIG. 17 where the glass panel and substrate are shown in a bent post-installation position;

FIG. 20 is a side plan view of the exemplary bendable glass and substrate assembly illustrated in FIG. 17 where the glass panel and substrate are shown in the bent post-installation position;

FIG. 21 is a front perspective view of an exemplary bendable glass and substrate assembly where the glass panel has been configured as a lens and is shown in a planar pre-installation position; and

FIG. 22 is a front perspective view of the exemplary bendable glass and substrate assembly illustrated in FIG. 21 where the glass panel is shown in a bent post-installation position.

### DETAILED DESCRIPTION

Example embodiments will now be described more fully with reference to the accompanying drawings. Wherever possible, the same reference numbers will be used throughout the drawings to refer to same or like parts.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

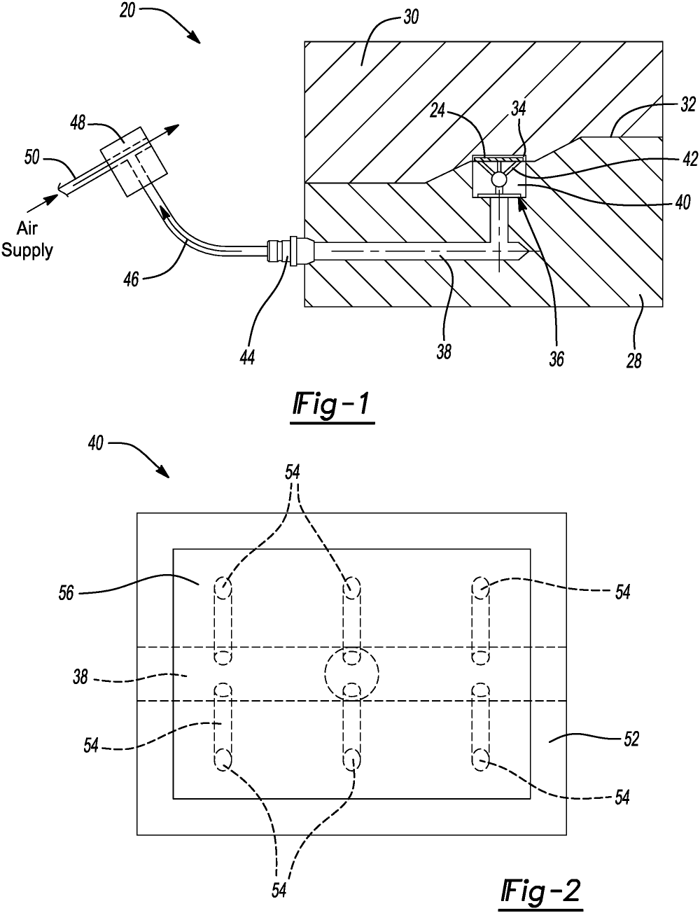

With reference the Figures, a encapsulation mold 20 used in a method of manufacturing a bendable glass and substrate assembly 22 is illustrated. Although other configurations are possible, in the illustrated embodiment the encapsulation mold 20 is a glass encapsulation mold that is adapted to encapsulate, laminate, or coat a flat pre-molded glass panel 24 with one or more layers of a flexible resin substrate 26. With reference to FIG. 1, the encapsulation mold 20 includes generally a first mold half 28 and a second mold half 30 that are arranged to move relative to one another between open and closed positions. In the closed position, the first and second mold halves 28, 30 mate at a mold interface 32 that defines a mold cavity 34, which is configured to (i.e., its size and shape are adapted to) receive the flat pre-molded glass panel 24. The first mold half 28 includes a vacuum block cavity 36 and a vacuum manifold 38. The vacuum block cavity 36 receives a vacuum block 40, which includes a plurality of vacuum passageways 42 that are arranged in fluid communication with the vacuum manifold 38 in the first mold half 28. An air fitting 44 is connected to the first mold half 28 and is arranged in fluid communication with the vacuum manifold 38 and a vacuum line 46 connects the air fitting 44 to a vacuum generator 48. In the illustrated example, the vacuum generator 48 is a venturi-style vacuum generator that is connected to an air supply 50; however, it should be appreciated that a variety of different vacuum generators may be employed.

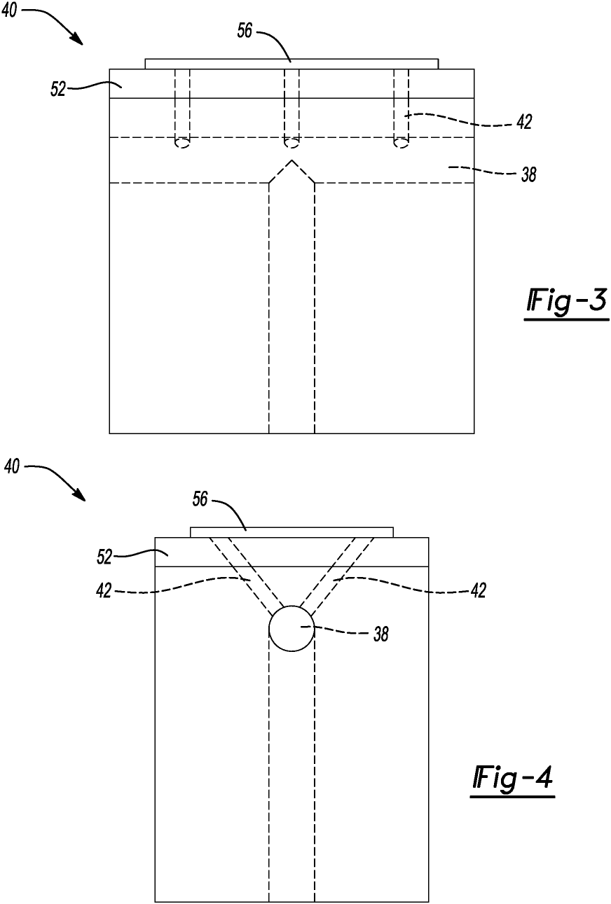

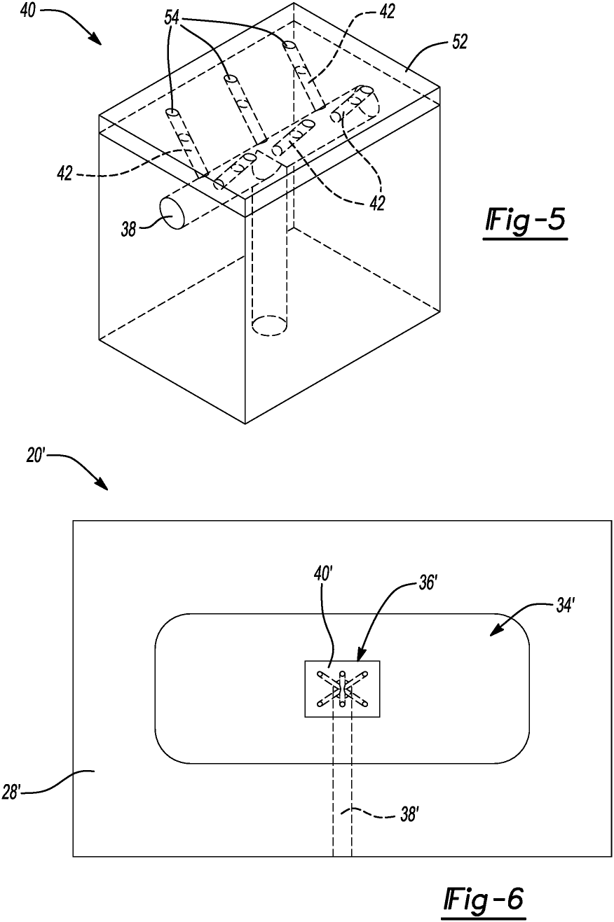

With additional reference to FIGS. 2-5, several details of the vacuum block 40 are shown. Although other configurations are possible, in the illustrated example, the vacuum block 40 is generally rectangular in shape and includes a flat rigid platen 52 with a plurality of vacuum ports 54 therein. These vacuum ports 54 in the rigid platen 52 are arranged in fluid communication with the vacuum passageways 42 in the vacuum block 40. The encapsulation mold 20 further includes one or more flexible urethane pads 56 that are positioned in the mold cavity 34 between the rigid platen 52 and the flat pre-molded glass panel 24. Each flexible urethane pad 56 is porous such that a vacuum pulled through the vacuum manifold 38 in the first mold half 28 operates through openings in the flexible urethane pad(s) 56 and holds the flat pre-molded glass panel 28 in place when the flexible resin substrate 26 is injected into the mold cavity 34. In accordance with an aspect of the subject disclosure, the urethane material forming the flexible urethane pad(s) 56 has a durometer of 50 to 90 Shore A.

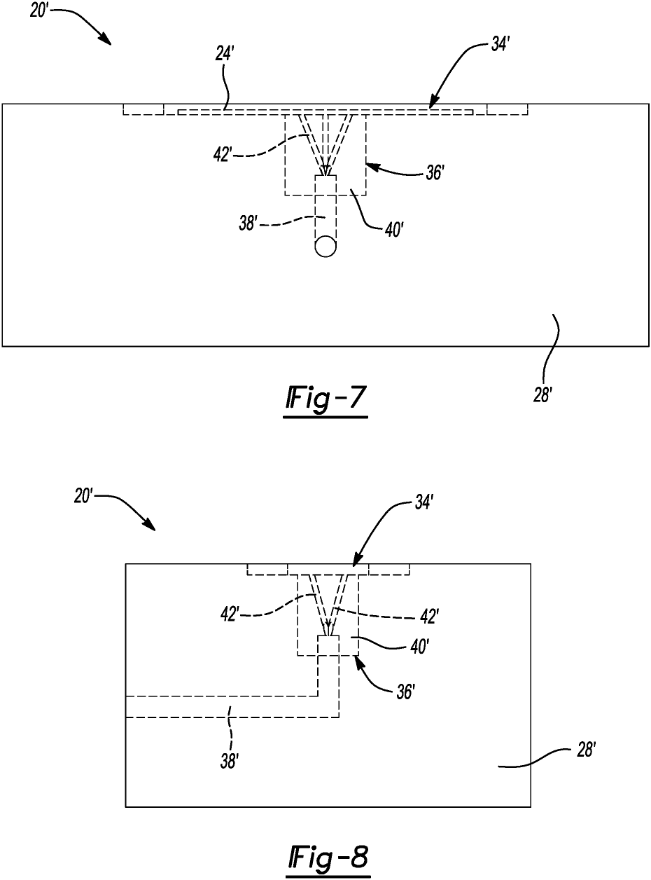

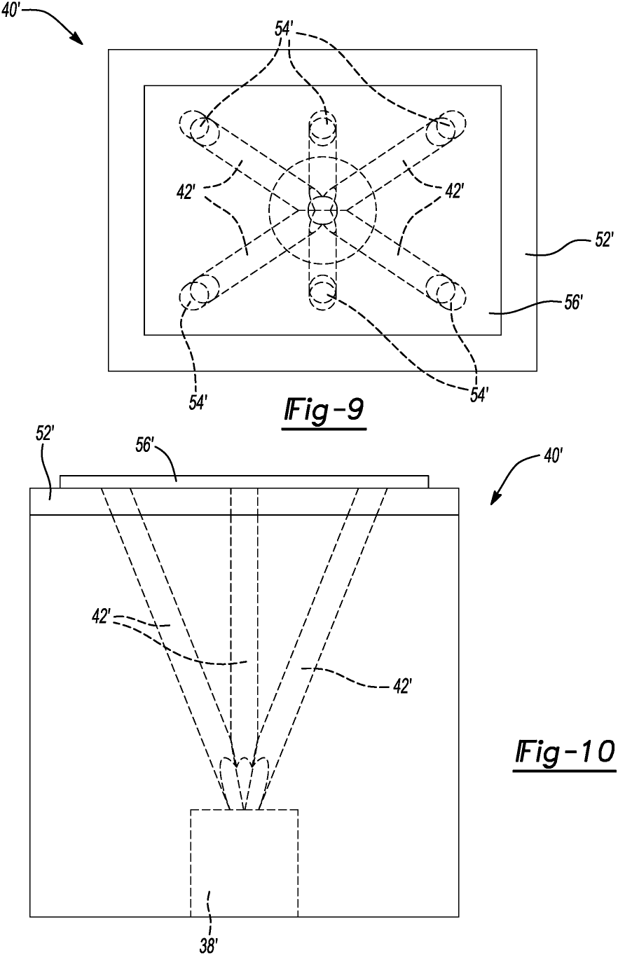

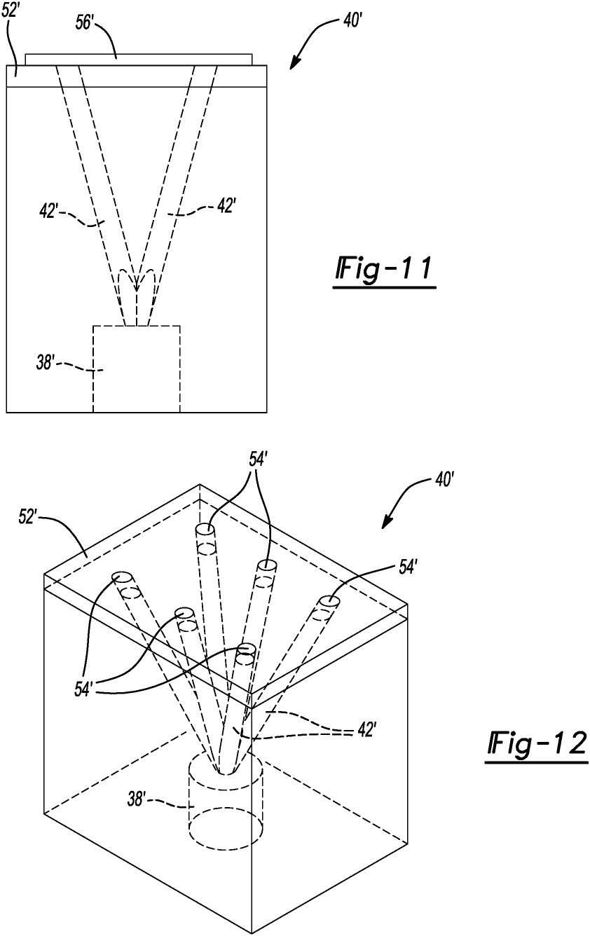

FIGS. 6-12 illustrate another exemplary vacuum block 40′, where the vacuum passageways 42′ have an alternative configuration. Notwithstanding the different part geometries, the encapsulation mold 20′ and vacuum block 40′ illustrated in FIGS. 6-12 operates the same way as the encapsulation mold 20 and vacuum block 40 shown in FIGS. 1-5. Like in the embodiment shown in FIGS. 1-5, the encapsulation mold 20′ illustrated in FIGS. 6-12 includes a mold cavity 34′, which is configured to receive the flat pre-molded glass panel 24. The first mold half 28′ includes a vacuum block cavity 36′ and a vacuum manifold 38′. The vacuum block cavity 36′ receives the vacuum block 40′, which includes a plurality of vacuum passageways 42′ that are arranged in fluid communication with the vacuum manifold 38′ in the first mold half 28′. This embodiment also includes a flat rigid platen 52′ with vacuum ports 54′ that draw a vacuum through one or more flexible urethane pads 56′. Notwithstanding these illustrated examples, it should be appreciated that additional mold configurations are possible. For example and without limitation, the rigid platens 52, 52′ illustrated in FIGS. 1-12 could be integrated into the vacuum block 40, 40′ in either arrangement. Similarly, the rigid platen 52, 52′ and/or the vacuum block 40, 40′ itself could be integrated into the first mold halves 28, 28′ shown in FIGS. 1-12.

The method of manufacturing the bendable glass and substrate assembly 22 includes the steps of the placing a flat pre-molded glass panel 24 in the mold cavity 34, 34′ of the encapsulation mold 20, 20′, drawing a vacuum on the vacuum passageways 42, 42′ in the vacuum block 40, 40′ to hold the flat pre-molded glass panel 24 in place, bonding the flexible resin substrate 26 to at least a portion of the glass panel 24 by injecting the flexible resin substrate 26 into the mold cavity 34, 34′, and removing the bendable glass and substrate assembly 22 from the encapsulation mold 20, 20′. It should be appreciated that in accordance with one aspect of the subject disclosure, the bendable glass and substrate assembly 22 has a planar pre-installation geometry after the bonding step. This planar pre-installation geometry is generally flat and free of any bends, dips, curves, or contours. It is therefore important to note that in accordance with this aspect of the subject disclosure, the encapsulation mold does not mold or otherwise apply contours to the glass panel 24. Instead, the purpose of encapsulation mold 20, 20′ is to apply one or more layers of flexible resin substrate 26 (i.e., one or more layers of the same substrate or layers of different substrates) to the glass panel 24. Any molding of the glass panel 24 occurs before the glass panel 24 is placed in the mold cavity 34, 34′ of the encapsulation mold 20, 20′.

Notwithstanding the foregoing, in accordance with another aspect of the subject disclosure, a mold may be used that changes the shape of the pre-molded glass panel 24 in addition to applying the flexible resin substrate 26 to the glass panel 24. In accordance with this aspect of the subject disclosure, the glass panel 24 is loaded into the mold in the planar pre-installation geometry described above, but exits the mold in an intermediate geometry that may have intermediate or non-final bends, curves, or contours. This means that the bendable glass and substrate assembly 22 is adapted to be bent or shaped further (e.g., to a greater degree) than the intermediate geometry when the bendable glass and substrate assembly 22 is later installed in accordance with this aspect of the subject disclosure.

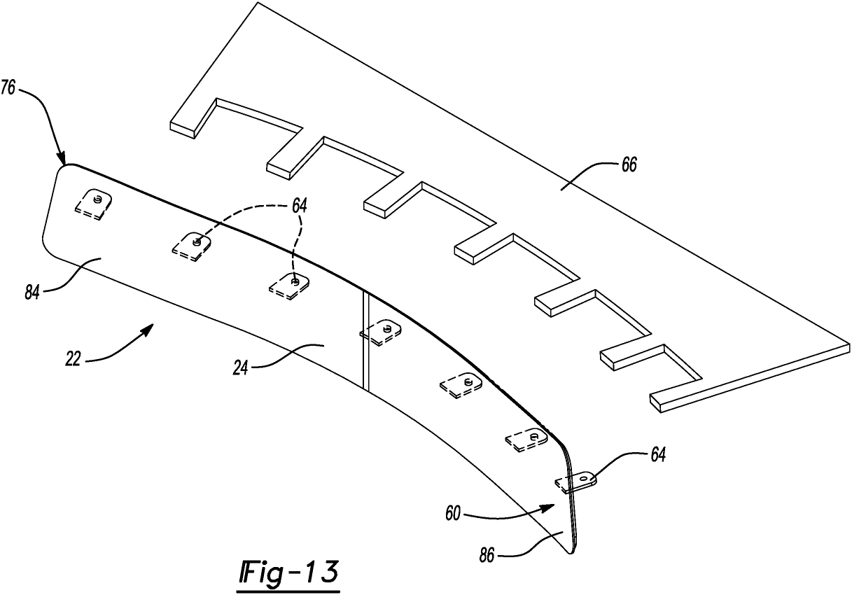

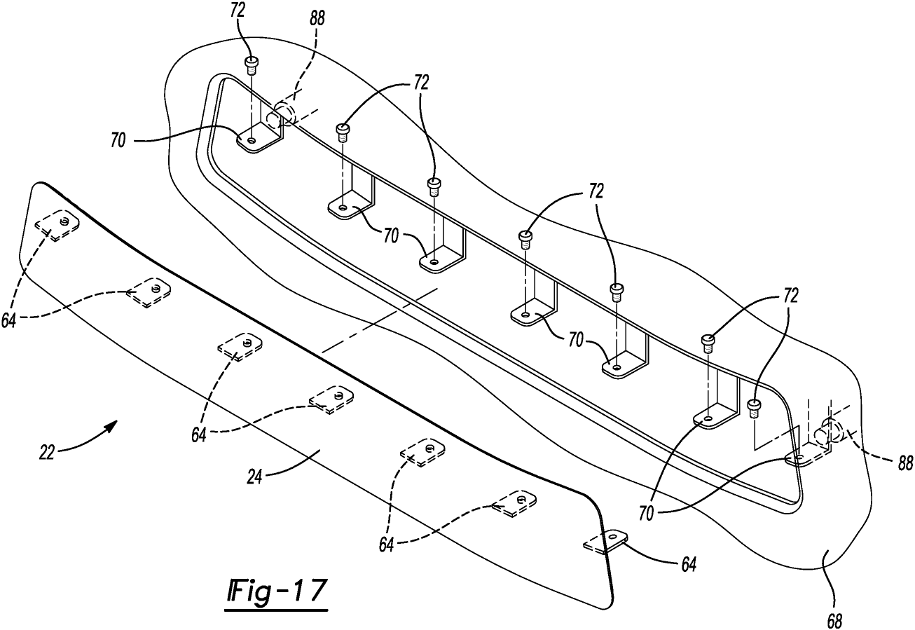

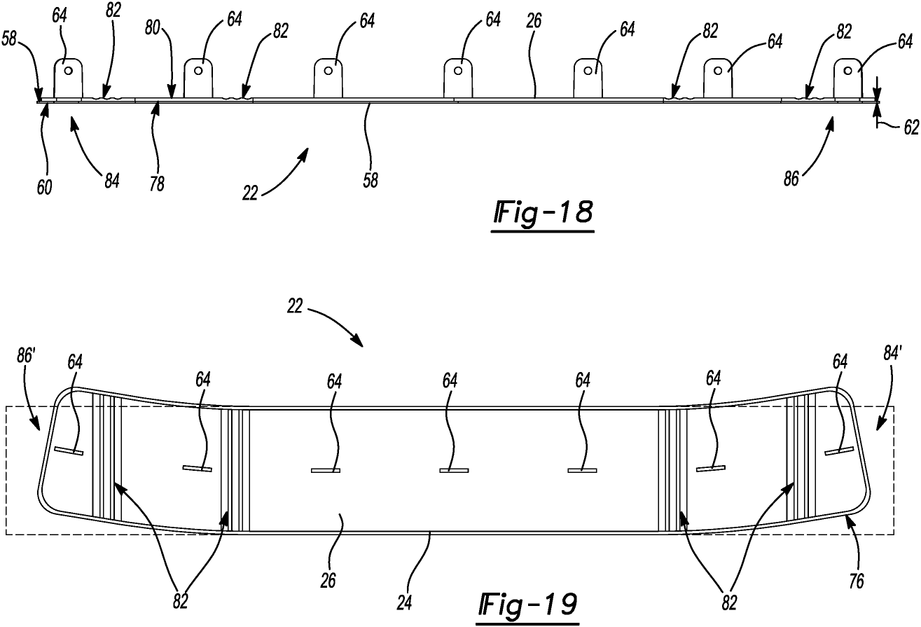

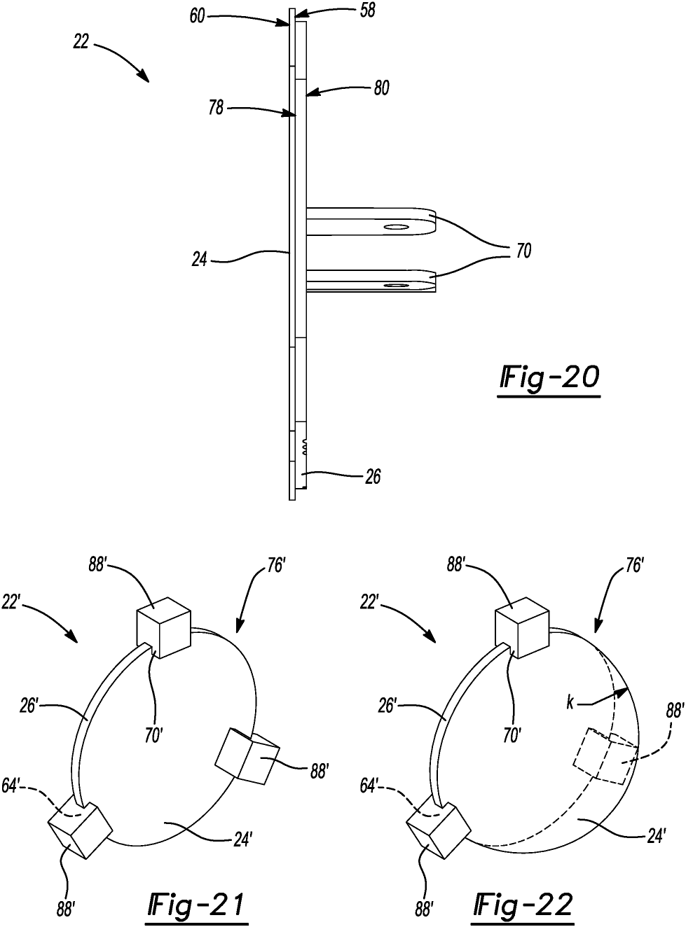

With additional reference to FIGS. 13-20, the pre-molded glass panel 24 has first and second panel surfaces 58, 60 that are separated by a panel thickness 62. In accordance with the manufacturing method described herein, the flexible resin substrate 26 may be bonded to all of portions of the first and second panel surfaces 58, 60; however, the encapsulation molds 20, 20′ illustrated herein are specifically configured to bond the flexible resin substrate 26 to all or portions of the first panel surface 58, which faces the vacuum block 40, 40′ when the flat pre-molded glass panel 24′ is loaded into the mold cavity 34, 34′.

The method may also include the step of forming a plurality of attachment features 64 in the flexible resin substrate 26. The step of forming the plurality of attachment features 64 in the flexible resin substrate 26 may include installing the bendable glass and substrate assembly 22 on a jig 66 after the step of removing the bendable glass and substrate assembly 22 from the encapsulation mold 20, 20′. In accordance with this aspect of the manufacturing method, the step of installing the bendable glass and substrate assembly 22 on the jig 66 includes bending the bendable glass panel and substrate assembly 22 to a bent post-installation geometry, securing the bendable glass and substrate assembly to the jig 66 in the bent post-installation geometry, forming the plurality of attachment 64 features in the flexible resin substrate 26 while the bendable glass and substrate assembly 22 is held in the bent post-installation geometry by the jig 66, and removing the bendable glass and substrate assembly 22 from the jig 66. The attachment features 64 on the substrate 26 may have a variety of different forms and configurations. By way of non-limiting example only, the attachment features 64 may be mounting holes that extend through the substrate 26 such that the method step of forming the plurality of attachment features 64 in the flexible resin substrate 26 may include punching mounting holes in the flexible resin substrate 26 while the bendable glass and substrate assembly 22 is installed on the jig 66 in the bent post-installation geometry, for example. Using the jig 66 in accordance with this process therefore ensures that the attachment features 64 in the substrate 26 are properly located/positioned to give the bendable glass and substrate assembly 22 a particular/desired final shape when it is installed in the post-installation geometry. However, it should also be appreciated that because both the glass panel 24 and the flexible resin substrate 26 are made of bendable materials, the bendable glass and substrate assembly 22 will return to the planar pre-installation geometry after being removed from the jig 66. This memory/resilience of the bendable glass and substrate assembly 22, which allows it to return to the planar pre-installation geometry is advantageous. For example, there are shipping and handling benefits because the bendable glass and substrate assembly 22 takes up less space (i.e., is flatter and more stackable) than permanently molded glass substrate assemblies and is also less prone to damage during shipping and handling.

The methods described herein further include the step of installing the bendable glass and substrate assembly 22 on a fixture 68. In the context of these methods, the fixture 68 is the structure to which the bendable glass and substrate assembly 22 is ultimately installed. The step of installing the bendable glass and substrate assembly 22 on the fixture 68 includes bending the bendable glass and substrate assembly 22 to at least one bent post-installation geometry that is different than the planar pre-installation geometry and fixably mounting the bendable glass and substrate assembly 22 to the fixture 68 to hold the bendable glass and substrate assembly 22 in the bent post-installation geometry. In other words, the bendable glass and substrate assembly 22 is shaped to a final curve or contour during the step of installing the bendable glass and substrate assembly 22 on the fixture 68. This aspect of the methods described herein may therefore include positioning the bendable glass and substrate assembly 22 over the fixture 68, bending the bendable glass and substrate assembly 22 to the bent post-installation geometry, and securing the attachment features 64 on the substrate 26 of the bendable glass and substrate assembly 22 to the fixture 68 to hold the bendable glass and substrate assembly 22 in the bent post-installation geometry.

The step of installing the bendable glass and substrate assembly 22 on the fixture 68 may include attaching the plurality of attachment features 64 on the flexible resin substrate 26 to a plurality of retaining features 70 on the fixture 68, using fasteners 72, for example. By way of example and without limitation, the fasteners 72 may be screws, bolts, rivets, push-pins, alligator clips, and the like. Alternatively, the plurality of attachment features 64 on the flexible resin substrate 26 may be configured to engage (e.g., snap into or lock with) the plurality of retaining features 70 on the fixture 68 or may be secured to the plurality of retaining features 70 on the fixture 68 using heat stakes, ultrasonic welding, adhesive, or acrylic foam tape, for example. Regardless of the configuration, the step of attaching the plurality of attachment features 64 on the flexible resin substrate 26 to the plurality of retaining features 70 on the fixture 68 can operate to guide the bending of the bendable glass and substrate assembly 22 to the bent post-installation geometry.

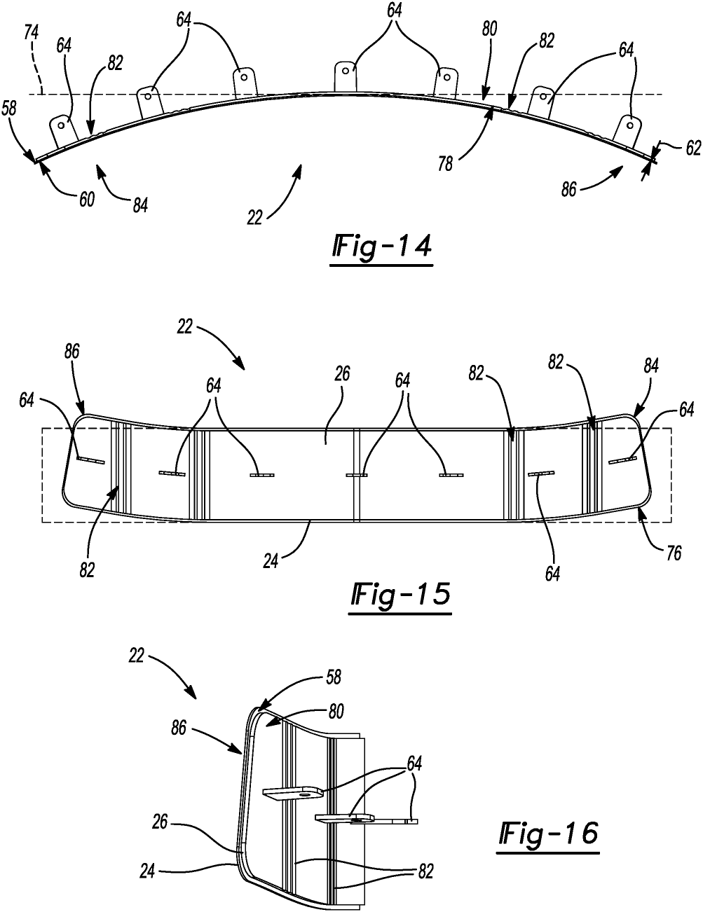

FIGS. 13-20 show the bendable glass and substrate assembly 22 after removal from the encapsulation mold 20, 20′ and illustrate the planar pre-installation geometry and a number of the bent post-installation geometries. As illustrated by in the dashed lines in FIGS. 14, 15, and 19, the glass panel 24 has a planar pre-installation geometry. The glass panel 24 also includes first and second panel surfaces 58, 60 that are separated by the panel thickness 62. To facilitate bending of the glass panel 24, the panel thickness 62 is preferably 0.5 to 0.7 millimeters (mm) thick. The first and second panel surfaces 58, 60 extend parallel to a reference plane 74 in the planar pre-installation geometry of the bendable glass and substrate assembly 22. The glass panel 24 also has a peripheral edge 76 that follows a first shape in the planar pre-installation geometry. Although other shapes are possible, in the illustrate examples, the first shape of the peripheral edge 76 is generally rectangular.

The flexible resin substrate 26 is bonded to at least a portion of the first panel surface 58. In the case of the illustrated examples, a single layer of substrate 26 is bonded to an extends across (i.e., is coextensive with) and covers the entire area of the first panel surface 58. However, it should be appreciated that the substrate 26 may extend over only part of the first panel surface 58, may extend over the peripheral edge 76 of the glass panel 24, and/or may extend over part or all of the second panel surface 60. Additionally, the substrate 26 may include multiple layers of the same or different flexible resin materials. Regardless of the particular configuration, the substrate 26 includes an anterior surface 78 that is bonded to the first panel surface 58 and a posterior surface 80 opposite the anterior surface 78.

Critically, both the glass panel 24 and the one or more layers of substrate 26 are made of bendable materials and are adapted to take on at least one bent post-installation geometry that is different than the planar pre-installation geometry. Additionally, the bendable materials of the glass panel 24 and the one or more layers of substrate 26 must be selected so that they remain bendable/flexible and resilient after encapsulation/bonding. By way of example and without limitation, the bendable material forming the glass panel 24 may be borosilicate glass, aluminosilicate glass, or soda-lime glass. In addition, the glass panel 24 may be chemically tempered with an ion exchange process to improve its response to bending stresses. By way of example and without limitation, the bendable substrate 26 may be thermoplastic or thermoset resins such as polyurethane, polyurea, polyvinylchloride, thermoplastic elastomers, thermoplastic vulcanizate, or thermoplastic olefin, for example.

Optionally, one or more relief cuts 82 may also be provided in the posterior surface 80 of the substrate 26 to enhance the articulation of the substrate 26 when the bendable glass and substrate assembly 22 are bent from the planar pre-installation geometry to the at least one bent post-installation geometry. The bendable glass and substrate assembly 22 may also include a plurality of attachment features 64 formed in the substrate 26. These attachment features 64 provide a plurality of attachment points that are adapted to fixably secure and hold the bendable glass and substrate assembly 22 in the at least one bent post-installation geometry. Although other configurations are possible, in the illustrated examples, the attachment features 64 are tabs that extend outwardly from the posterior surface 80 of the substrate 26 and include mounting holes that extend through the tabs in the substrate 26. As noted above, a jig 66 that is adapted to receive the bendable glass and substrate assembly 22 may be used to hold the bendable glass and substrate assembly 22 in the at least one bent post-installation geometry as the mounting holes are being punched in the tabs of the substrate 26.

The bendable glass and substrate assembly 22 is specifically adapted to be installed on a fixture 68. When the bendable glass and substrate assembly 22 is installed, the plurality of attachment features 64 in the substrate 26 are attached to retaining features 70 on the fixture 68 to hold the bendable glass and substrate assembly 22 in the at least one bent post-installation geometry. In one non-limiting example, a plurality of fasteners 72 are received in the mounting holes in the substrate 26 to secure the tabs to retaining features 70 such as bosses on the fixture 68.

As shown by the solid lines in FIGS. 13-20, the first and second panel surfaces 58, 60 have a non-planar shape, bend, or contour in the bent post-installation geometry of the bendable glass and substrate assembly 22 that is not present in the planar pre-installation geometry of the bendable glass and substrate assembly 22. For example, FIG. 14 illustrates how the bendable glass and substrate assembly 22 includes end portions 84, 86 where the first and second panel surfaces 58, 60 are curved or bent away from the reference plane 74 in the bent post-installation geometry of the bendable glass and substrate assembly 22. FIGS. 15 and 19 illustrate how these end portions 84, 86 of the of the bendable glass and substrate assembly 22 can also be bent in-plane (i.e., curved or bent in the reference plane 74) such that the peripheral edge 76 follows the first shape, illustrated as rectangle, in the planar pre-installation geometry and a second shape, illustrated as a rectangle with upwardly curved/bowed end portions 84′, 86′, in the bent post-installation geometry. Either way, an installation force is applied to the bendable glass and substrate assembly 22, which causes the bendable glass and substrate assembly 22 to flex into position on the fixture 68 and assume at least one bent, post-installation geometry.

The bendable glass and substrate assemblies 22 described herein may be used in a number of different applications. For example, it is envisioned that the bendable glass and substrate assemblies 22 described herein may find particular utility in vehicle applications. In one exemplary automotive application, the glass panel 24 of the bendable glass and substrate assembly 22 is configured as a vehicle display screen, gauge cluster, dash panel, or digital switch panel. In accordance with this embodiment, the glass panel 24 may be smooth and transparent and the fixture 68 to which the bendable glass and substrate assembly 22 is attached is part of a vehicle interior. In other examples, the glass panel 24 of the bendable glass and substrate assembly 22 may be configured as a screen of an electronic display such as touch screens on consumer electronics or consumer appliances, a flex screen, a light pipe, or decorative panel. For example, the glass panel 24 may include a design, be printed on, or may include artwork. In another exemplary automotive application, the glass panel 24 of the bendable glass and substrate assembly 22 is configured as a vehicle trim piece. In accordance with this embodiment, the glass panel 24 may be smooth or textured and may be transparent, translucent, colored, tinted, or opaque. The fixture 68 to which the bendable glass and substrate assembly 22 is attached may again be part of a vehicle interior.

In accordance with another aspect of the subject disclosure, the retaining features 70 of the fixture 68 may be movable relative to one another between a first position limit and a second position limit. In such an arrangement, the retaining features 70 of the fixture 68 can hold the bendable glass and substrate assembly 22 in a first bent post-installation geometry when the retaining features 70 of the fixture 68 are at the first position limit and the retaining features 70 of the fixture 68 can hold the bendable glass and substrate assembly 22 in a second bent post-installation geometry when the retaining features 70 of the fixture 68 are at the second position limit. The second bent post-installation geometry of the bendable glass and substrate assembly 22 is different than both the planar pre-installation geometry and the first bent post-installation geometry. This means that the final, installed geometry of the bendable glass and substrate assembly 22 may dynamically change based on movement of the retaining features 70 of the fixture 68. In one example of this application, the fixture 68 may include a moveable component, such as part of a vehicle door, hand brake, sun visor, sunroof, etc. In accordance with this aspect of the subject disclosure, the bendable glass and substrate assembly 22 may be configured to bend or move to different bent post-installation geometries when the position of the fixture 68 or part of the fixture 68 is moved (e.g., the curve or contour of the bendable glass and substrate assembly 22 can change when the vehicle door opens and closes). In another example of this aspect of the subject disclosure, the bendable glass and substrate assembly 22 includes a plurality of actuators 88 on the fixture 68 that are adapted to move the retaining features 70 between the first position limit and the second position limit. The actuators 88 may be mechanical actuators (e.g., opening the vehicle door moves a mechanical actuator that changes the shape of the dash panel) or electric/pneumatic/hydraulic actuators 88 (e.g., pressing a button activates the actuator to change the shape of the dash panel).

FIGS. 22 and 23 illustrate yet another example of this aspect of the subject disclosure, where the glass panel 24′ of the bendable glass and substrate assembly 22′ is configured as a lens with a variable curvature k that changes depending on the positioning of the retaining features 70′ to adaptively focus the lens. In this application, the actuators 88′ are controlled to change the position of the attachment features 64′ in the substrate 26′, which are circumferentially spaced about the peripheral edge 76′ of the glass panel 24′, to adjust the curvature k and therefore the focal point of the glass panel 24′, which forms the lens.

While aspects of the present disclosure have been particularly shown and described with reference to the embodiments above, it will be understood by those skilled in the art that various additional embodiments may be contemplated by the modification of the disclosed dampers without departing from the spirit and scope of what is disclosed. Such embodiments should be understood to fall within the scope of the present disclosure as determined based upon the claims and any equivalents thereof.

What is claimed is:

1. An assembly, comprising:
a glass panel having a planar pre-installation geometry and first and second panel surfaces that are separated by a panel thickness; and
at least one substrate that is bonded to at least a portion of the first panel surface,
wherein both the glass panel and the at least one substrate are made of bendable materials and are adapted to take on at least one bent post-installation geometry that is different than the planar pre-installation geometry.

2. The assembly of claim 1, further comprising:
a plurality of attachment features formed in the substrate that provide a plurality of attachment points that are adapted to fixably secure and hold the glass panel and substrate in the at least one bent post-installation geometry.

3. The assembly of claim 2, further comprising:
a fixture onto which the glass panel and substrate are installed where the plurality of attachment features in the substrate are attached to retaining features on the fixture to hold the glass panel and substrate in the at least one bent post-installation geometry.

4. The assembly of claim 3, wherein the retaining features of the fixture are movable relative to one another between a first position limit and a second position limit such that the retaining features of the fixture hold the glass panel and substrate in a first bent post-installation geometry when the retaining features of the fixture are at the first position limit and the retaining features of the fixture hold the glass panel and substrate in a second bent post-installation geometry that is different than the planar pre-installation geometry and the first bent post-installation geometry when the retaining features of the fixture are at the second position limit.

5. The assembly of claim 4, further comprising:
a plurality of actuators on the fixture that are adapted to move the retaining features between the first position limit and the second position limit.

6. The assembly of claim 5, wherein the glass panel is configured as a lens with a variable curvature that changes depending on the positioning of the retaining features to adaptively focus the lens.

7. The assembly of claim 3, wherein the glass panel is configured as a vehicle display screen, dash panel, or vehicle trim piece and the fixture is part of a vehicle interior.

8. The assembly of claim 3, wherein the plurality of attachment features are mounting holes in the substrate that receive a plurality of fasteners that engage the retaining features on the fixture.

9. The assembly of claim 2, further comprising:
a jig adapted to receive the glass panel and substrate and hold the glass panel and substrate in the at least one bent post-installation geometry as the plurality of attachment features are being formed in the substrate.

10. The assembly of claim 1, wherein the first and second panel surfaces have a non-planar shape, bend, or contour in the bent post-installation geometry of the glass panel and substrate that is not present in the planar pre-installation geometry of the glass panel and substrate.

11. The assembly of claim 1, wherein the first and second panel surfaces extend parallel to a reference plane in the planar pre-installation geometry of the glass panel and substrate and at least a portion the first and second panel surfaces are curved or bent away from the reference plane in the bent post-installation geometry of the glass panel and substrate.

12. The assembly of claim 1, wherein the glass panel includes a peripheral edge that follows a first shape in the planar pre-installation geometry and a second shape in the bent post-installation geometry.

13. The assembly of claim 1, wherein the substrate includes an anterior surface that is bonded to the first panel surface, a posterior surface opposite the anterior surface, and one or more relief cuts in the posterior surface of the substrate that enhance articulation of the substrate when the glass panel and substrate are bent from the planar pre-installation geometry to the bent post-installation geometry.

14. A method of assembling a bendable glass and substrate panel, the method comprising the steps of:
placing a flat pre-molded glass panel in a encapsulation mold, the pre-molded glass panel having first and second panel surfaces that are separated by a panel thickness;
bonding a flexible resin substrate to at least a portion of the first panel surface by injecting the flexible resin substrate into the encapsulation mold to create a bendable glass and substrate assembly having a planar pre-installation geometry;
removing the bendable glass and substrate assembly from the encapsulation mold; and
installing the bendable glass and substrate assembly on a fixture,
wherein the step of installing the bendable glass and substrate assembly on the fixture includes bending the bendable glass and substrate assembly to a bent post-installation geometry that is different than the planar pre-installation geometry and fixably mounting the bendable glass and substrate assembly to the fixture to hold the bendable glass and substrate assembly in the bent post-installation geometry.

15. The method of claim 14, further comprising the step of:
forming a plurality of attachment features in the flexible resin substrate.

16. The method of claim 15, wherein the step of forming the plurality of attachment features in the flexible resin substrate includes installing the bendable glass and substrate assembly on a jig after the step of removing the bendable glass and substrate assembly from the encapsulation mold and before installing the bendable glass and substrate assembly on the fixture.

17. The method of claim 16, wherein the step of installing the bendable glass and substrate assembly on the jig includes bending the bendable glass panel and substrate assembly to the bent post-installation geometry, securing the bendable glass and substrate assembly to the jig in the bent post-installation geometry, forming a plurality of attachment features in the flexible resin substrate while the bendable glass and substrate assembly is held in the bent post-installation geometry by the jig, and removing the bendable glass and substrate assembly from the jig.

18. The method of claim 17, wherein the step of forming the plurality of attachment features in the flexible resin substrate includes punching mounting holes in the flexible resin substrate.

19. The method of claim 17, wherein the bendable glass and substrate assembly returns to the planar pre-installation geometry after being removed from the jig.

20. The method of claim 15, wherein the step of installing the bendable glass and substrate assembly on the fixture includes attaching the plurality of attachment features on the flexible resin substrate to a plurality of retaining features on the fixture and wherein the step of attaching the plurality of attachment features on the flexible resin substrate to the plurality of retaining features on the fixture operates to guide the bending of the bendable glass and substrate assembly to the post-installation geometry.

21. The method of claim 14, wherein the bendable glass and substrate assembly is shaped to a final curve or contour during the step of installing the bendable glass and substrate assembly on the fixture.

22. The method of claim 14, further comprising the steps of:
providing a vacuum block within the mold, the vacuum block including a flat rigid platen with a plurality of vacuum ports and at least one flexible urethane pad positioned in the mold between the rigid platen and the first panel surface of the flat pre-molded glass panel; and
drawing a vacuum on the vacuum block to hold the flat pre-molded glass panel in place during the bonding step,
wherein the at least one flexible urethane pad is porous such that the vacuum operates through openings in the flexible urethane pad.

23. A method of installing a bendable glass and substrate assembly, the method comprising the steps of:
positioning a bendable glass and substrate assembly over a fixture for installation, the bendable glass and substrate assembly having a planar pre-installation geometry and includes a flexible substrate that is bonded to a glass panel;
bending the bendable glass and substrate assembly to a bent post-installation geometry that is different than the planar pre-installation geometry; and
securing the bendable glass and substrate assembly to the fixture to hold the bendable glass and substrate assembly in the bent post-installation geometry.

24. The method of claim 23, wherein the steps of bending and securing the bendable glass and substrate assembly to the fixture includes attaching a plurality of attachment features formed in the flexible substrate to a plurality of retaining features on the fixture and wherein the step of attaching the plurality of attachment features on the flexible substrate to the plurality of retaining features on the fixture operates to guide the bending of the bendable glass and substrate assembly to the post-installation geometry.

25. The method of claim 23, wherein the bendable glass and substrate assembly is shaped to a final curve or contour during the steps of bending and securing the bendable glass and substrate assembly to the fixture.

26. The method of claim 23, wherein the glass panel is configured as a dash panel, vehicle trim piece, focusable lens, electronic display screen, or touchscreen.
